(19) United States
(12) Patent Application Publication
(10) Pub. No.: US 2007/0257556 A1
(43) Pub. Date: Nov. 8, 2007

(54) CHARGE INDICATOR FOR LIGHTWEIGHT UTILITY VEHICLE

(75) Inventors: Oliver A. Bell JR., Aiken, SC (US); Warren Clark, Evans, GA (US); Aric Singletary, Hephzibah, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/381,857

(22) Filed: May 5, 2006

(51) Int. Cl. B60L 1/00

(52) U.S. Cl. 307/9.1

(57) ABSTRACT

A power cell charge monitoring system for a light-weight utility vehicle is provided. The monitoring system can comprise a receptacle module electrically connectable to at least one power cell of the vehicle. The receptacle module is removably mateable with a power cell charger connector and can comprise at least one indicator light. The receptacle module can be configured to utilize the indicator light to indicate a charge status of the power cell when the receptacle module is mated with the charger connector.

### FIELD

The present disclosure relates to a battery charge indicator for a vehicle.

### BACKGROUND

Many known light-weight utility vehicles, such as small cargo/maintenance vehicles, shuttle vehicles or golf cars, are electrically powered. Typically, a battery, or a bank of more than one battery is employed to provide the electrical power used operate a vehicle prime mover, e.g., a DC motor, that generates motive force to propel the vehicle. Accordingly, such a battery or bank of batteries needs to be charged regularly, e.g., daily. To charge the battery/bank, an appropriate battery charger is typically connected to the battery/bank via a charge connector socket on the vehicle. Typically the charger will have a current meter that indicates current being drawn by the battery/bank during charging. When the current reading drops off significantly, it is generally concluded that the batteries are fully charged. However, many other things could cause the current reading to drop. For example, the battery or one of the batteries in a bank could have a bad cell, or the battery/bank could have a faulty connection to the charger. Additionally, the charger can be located in a location that is obstructed from view or not easily viewable such that the current meter is difficult or impossible to read. In which case, determination of a complete charge for the battery/bank is left to the interpretation of a maintenance operator tasked with charging the battery/bank. Thus, determination of when the battery/bank is fully charged can be subjective and inaccurate, resulting in potential damage to or shortened life of the battery/bank.

### SUMMARY

In various embodiments of the present disclosure a power cell charge monitoring system for a light-weight utility vehicle is provided. The monitoring system can comprise a receptacle module electrically connectable to at least one power cell of the vehicle. The receptacle module is removably mateable with a power cell charger connector and can comprise at least one indicator light, e.g., at least one light emitting diode (LED). In various implementations the receptacle module can be configured to utilize the indicator light to indicate a charge status of the power cell when the receptacle module is mated with the charger connector. For example, the receptacle module can steadily illuminate the indicator light to indicate that the power cell has a charge status of fully charged. Or, the receptacle module can sequentially flash the indicator light to indicate that the power cell has a charge status of presently charging.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a side view of the light-weight utility vehicle including a power cell charge monitoring system, in accordance with various embodiments of the present disclosure;

FIG. 2 is an isometric illustration of the connectivity of a receptacle module of the power cell charge monitoring system, shown in FIG. 1, to at least one vehicle power cell and a power cell charger;

FIG. 3 is an isometric view of the receptacle module shown in FIG. 2 comprising a controller, in accordance with various embodiments of the present disclosure; and

FIG. 4 is an isometric view of the receptacle module shown in FIG. 2 comprising a plurality of indicator lights, in accordance with various embodiments of the present disclosure.

### DETAILED DESCRIPTION

The following description of various embodiments is merely exemplary in nature and is in no way intended to limit the present teachings, application, or uses.

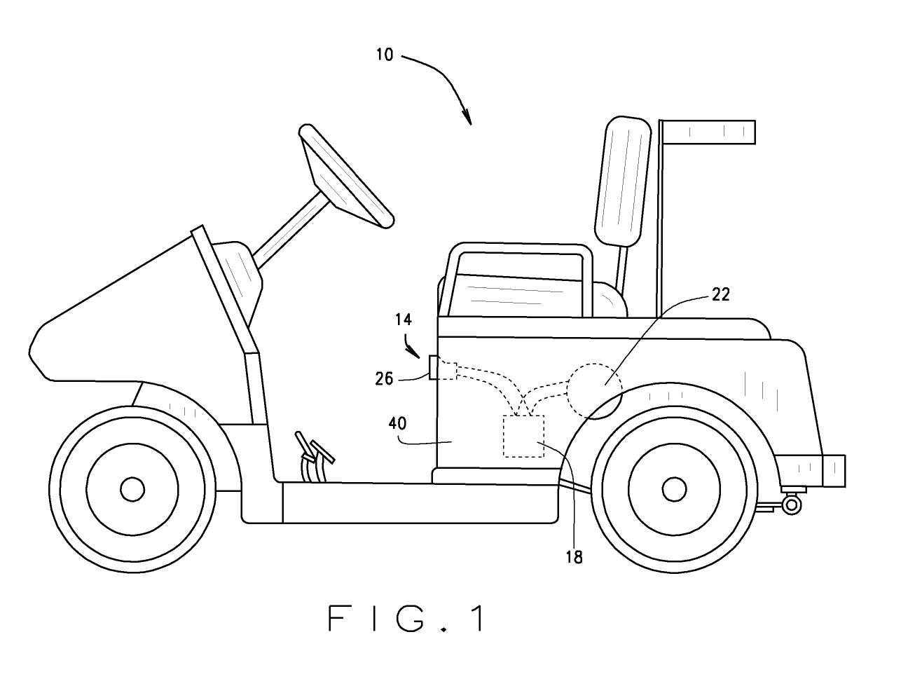

FIG. 1 illustrates a light-weight utility vehicle 10, such as a small cargo/maintenance vehicle, a shuttle vehicle or a golf car, that can comprise a power cell charge monitoring system 14 for monitoring a charge status of at least one vehicle power cell 18 during a charging procedure, in accordance with various embodiments of the present disclosure. More particularly, the power cell charge monitoring system 14 indicates the charge status or power level of the power cell(s) 18, e.g., one or more 12 volt batteries, during charging of the power cell(s) 18. For example, the power cell charge monitoring 14 can indicate when the power cell(s) are presently being charged, one-quarter charged, one-half charged, three-quarters charged and/or fully charged.

The power cell(s) 18 provide power to a vehicle prime mover 22, such as an electric motor, that provides motive force to vehicle 10. Generally, the power level of the power cell(s) 18 depletes as the vehicle 10 is used, i.e., driven. Accordingly, the power level of the power cell(s) 18 must be replenished on a regular basis, via the charging procedure, to maintain an adequate power source to operate the vehicle 10. Thus, the charging procedure of the power cell(s) 18 can also be referred to as a recharging procedure.

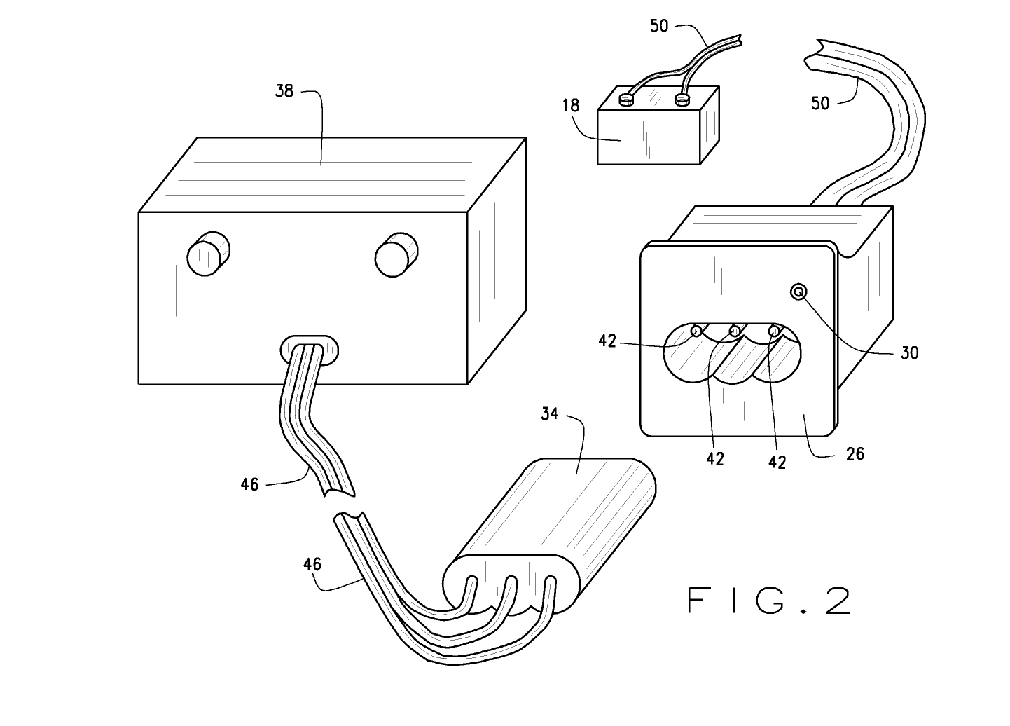

Referring now also to FIG. 2, the power cell charge monitoring system 14 can comprise a receptacle module 26 that includes at least one indicator light 30. The indicator light(s) 30 can be any suitable light emitting component(s), for example, light emitting diode(s) (LED). The receptacle module 26 is electrically connectable to the power cell(s) 18 and removably mateable with a power cell charger connector 34 of a power cell charger 38. Although the receptacle module 26 is exemplarily illustrated in FIG. 2 as having a ‘female’ type receiving connector and the charger connector 34 is exemplarily illustrated as being a ‘male’ type insertion connector, it should be understood that the receptacle module 26 could comprise a ‘male’ type connector and the charger connector could be a ‘female’ type connect and remain within the scope of the present disclosure. The receptacle module 26 can be located in any suitable location on the vehicle 10. For example, in various implementations, the receptacle module 26 can be conveniently mounted within a body portion 40 in an easily accessible location.

The receptacle module 26 additionally includes at least one communications terminal 42 for communicating electrical signals, e.g., electrical current, and/or data signals between the receptacle module 26 and the charger 38. For example, the charger 38 can transmit current signals through a power/communications cord 46 to the communication terminal(s) 42, via the charger connector 34, when the charger connector 34 is mated with the receptacle module 26. The current signals can then be transmitted to the power cell(s) 18 via a charge/communications cord 50 in electrical communication with the communications terminal(s) 42. Accordingly, the power cell(s) 18 can be charged to replenish the power level of the power cell(s) 18.

In various embodiments, during the charging procedure, the charger 38 can monitor the power, or charge, level of the power cell(s) 18, via the communication terminal(s) 42, the charge/communications cord 50 and the power/communications cord 46. The charger 38 can additionally transmit charge level data signals to the receptacle module 26, via the power/communications cord 46 and the communication terminal(s) 42. The charge level data signals indicate the present charge status of the power cell(s) 18, as monitored by the charger 38.

In various implementations, the receptacle module 26 utilizes a single indicator light 30 to indicate the charge status of the power cell(s) 18 based on the charge level data signals transmitted from the charger 38. For example, if the charge level data signals indicate that the power cell(s) 18 is/are presently charging and not yet fully charged, the receptacle module 26 can sequentially flash the indicator light 30. Additionally, if the charge level data signals indicate that the power cell(s) 18 have reached a fully charged level, the receptacle module 26 can steadily illuminate the indicator light 30. In other various embodiments, the receptacle module 26 can sequentially flash the indicator light 30 in distinct temporal patterns to indicate other charge levels, such as one-quarter charged and three-quarter charged.

As illustrated in FIG. 2, in some implementations the receptacle module 26 can comprise three communications terminals 42. In these implementations, two of the communications terminals 42 are utilized to transmit electrical signals for charging the power cell(s) 18 and monitoring the charge level of the power cell(s) 18, as described above. The third communications terminal 42 is employed to receive the charge level data signals transmitted by the charger 38 and utilized by the receptacle module 26 to illuminate the indicator light(s) 30 to indicate the charge status of the power cell(s) 18, as described above.

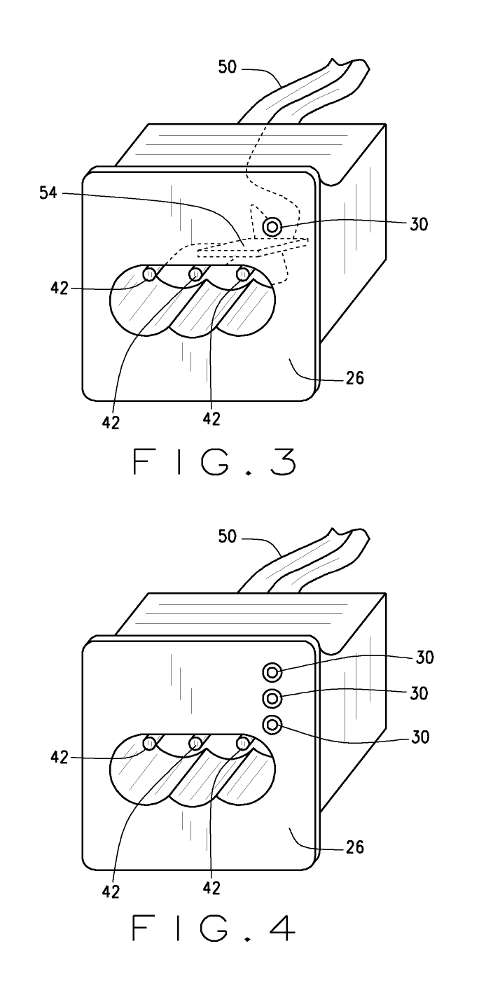

Referring to FIG. 3, in various embodiments, the receptacle module 26 can comprise a controller 54, e.g., a microcontroller or microprocessor, programmed to communicate with the charger 38 and control the illumination of the indicator light(s) 30. Generally, the controller 54 communicates with the charger 38 to determine the charge status of the power cell(s) 18 and illuminates the indicator light(s) 30 to indicate the charge status. For example, when the charger connector 34 is mated with the receptacle module 26 and the power cell(s) 18 is/are charging, the controller 54 could sequentially flash the indicator light(s) 30. And, when the power cell(s) 18 are fully charged, the controller 54 could steadily illuminate the indicator light(s) 18. Additionally, in various embodiments, the controller 54 can be programmed to communicate with the charger 38 and the power cell(s) 18 to determine operational data of the power cell(s) 18 and indicate such operation data via illumination of the indicator light(s) 30. For example, the controller 54 can be programmed to determine power cell operational data such as an amount of power used, a type of charge termination, length of run time, and power cell temperature. The controller 54 can then indicate such operational data by illuminating the indicator light(s) 30 in various particular temporally sequential flashing patterns specific to each of the operational data.

In such embodiments, the receptacle module 26 can also comprise a plurality of communications terminals 42 wherein at least one of the communications terminals 42 is a data terminal mateable with a bus port of the charger connectors 34. Accordingly, the power/communications cord 46 can comprise a data bus connectable to the controller 54 via the data communications terminal 42. The data bus can be any suitable data bus, for example, a CAN (controller area network) bus or RS232 bus. Thus, when the charger connector 34 is mated with the receptacle module 26, the charger 38 and controller 54 can communicate power cell operational data over the data bus. Furthermore, in various other embodiments, the controller 54 can be programmed to monitor and indicate various power cell operational data during operation of the vehicle 10. That is, the controller can communicate with the power cell(s) 18 during operation of the vehicle 10, when the charger connector 34 is not mated with the receptacle module 26, and control illumination of the indicator light(s) to indicate the power cell operational date. For example, the controller 54 could determine and indicate power cell operational data such as an amount of power used, run time, and temperature. The controller 54 can then indicate such operational data by illuminating the indicator light(s) 30 in various particular temporally sequential flashing patterns specific to each of the operational data.

Referring now to FIG. 4, in various embodiments, the receptacle module 26 can comprise a plurality of indicator lights 30, e.g., three indicator lights 30, to indicate the charge status and/or operational data of the power cell(s) 18. In some implementations, each of the indicator lights 30 can be of a different color such that a different color indicator light 30 would be illuminated, either steadily or sequentially flashed, to indicate charge status and/or operational data. For example, when the charger connector 34 is mated with the receptacle module 26 during the charging procedure, a green indicator light 30 could be illuminated, steadily or sequentially flashed, to indicate that the power cell(s) 18 are presently charging. And, when the power cell(s) is/are fully charged, a red indicator light 30 could be illuminated, steadily or sequentially flashed. Additionally, an amber indicator light 30 can be sequentially flashed to indicate various states of the power cell(s) 18 charge, e.g., one-quarter charged, one-half charged and three-quarters charged. Alternatively, all of the indicator lights 30 can be illuminated in combination, steadily or sequentially flashed, to indicate the charge status of the power cell(s) 18.

Referring now to FIGS. 3 and 4, in various embodiments the controller 54 can control illumination of the indicator lights 30 when the charger connector 34 is mated with the receptacle module 26. That is, the controller 54 can independently illuminate, steadily or sequentially flash, the indicator lights 30 to indicate charge status. Or, the controller 54 can illuminate the indicator lights 30 in combination, steadily or sequentially flashed, to indicate charge status. Furthermore, the controller 54 can control illumination of the indicator lights 30, independently or in combination, steadily or sequentially flashed, and when the connector 34 is or is not mated with the receptacle module 26, to indicate various power cell operational data.

Thus, the power cell charge monitoring system 14, comprising the receptacle module 26, as describe herein, provides a convenient, informative and accurate system for providing various power cell information. For example, in various embodiments, the system 14 can provide charging status information during charging of the power cell(s) 18 in a timely, accurate and convenient manner. Additionally, in various embodiments, the system 14 can accurately and conveniently provide power cell operational data.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A power cell charge monitoring system for a light-weight utility vehicle, said monitoring system comprising a receptacle module electrically connectable to at least one power cell of the vehicle and removably mateable with a power cell charger connector, the receptacle module comprising at least one indicator light and configured to utilize the indicator light to indicate a charge status of the power cell when the receptacle module is mated with the charger connector.

2. The vehicle of claim 1, wherein the receptacle module is configured to steadily illuminate the indicator light to indicate a charge status of fully charged.

3. The vehicle of claim 1, wherein the receptacle module is configured to sequentially flash the indicator light to indicate a charge status of presently charging.

4. The vehicle of claim 1, wherein the receptacle module further comprises a controller configured to control illumination of the indicator light to indicate the charge status of the power cell.

5. The vehicle of claim 4, wherein the controller is further configured to control illumination of the indicator light to indicate operational data of the power cell.

6. The vehicle of claim 5, wherein power cell operational data comprises at least one of amount power used, type of charge termination, hours of run time, and power cell temperature.

7. The system of claim 1, wherein the receptacle module is further configured to be mounted in a body portion of the vehicle such that the receptacle module is easily accessible.

8. A light-weight utility vehicle, said vehicle comprising:
at least one power cell for providing power to a vehicle prime mover; and
a receptacle module mounted in a body portion of the vehicle, the receptacle module electrically connectable to the power cell and removably mateable with a power cell charger connector, the receptacle module comprising at least one indicator light and configured to utilize the indicator light to indicate a charge status of the power cell when the receptacle module is mated with the charger connector.

9. The vehicle of claim 8, wherein the receptacle module is configured to steadily illuminate the indicator light to indicate a charge status of fully charged.

10. The vehicle of claim 8, wherein the receptacle module is configured to sequentially flash the indicator light to indicate a charge status of presently charging.

11. The vehicle of claim 8, wherein the receptacle module further comprises a controller configured to control illumination of the indicator light to indicate the charge status of the power cell.

12. The vehicle of claim 11, wherein the controller is further configured to control illumination of the indicator light to indicate operational data of the power cell.

13. The vehicle of claim 12, wherein power cell operational data comprises at least one of amount power used, type of charge termination, hours of run time, and power cell temperature.

14. A power cell charge monitoring system for a light-weight utility vehicle, said monitoring system comprising a receptacle module mounted in a body portion of the vehicle, the receptacle module electrically connectable to at least one vehicle power cell and removably mateable with a power cell charger connector, the receptacle module comprising at least one indicator light and configured to utilize the indicator light to indicate when the power cell is fully charged.

15. The system of claim 14, wherein the receptacle module is further configured to steadily illuminate the indicator light when mated with the charger connector and the power cell is fully charged.

16. The system of claim 14, wherein the receptacle module is further configured to utilize the indicator light to indicate when the power cell is not fully charged.

17. The system of claim 16, wherein the receptacle module is further configured to sequentially flash the indicator light when mated with the charger connector and the power cell is not fully charged.

18. The system of claim 14, wherein the receptacle module further comprises a controller configured to control illumination of the indicator light to indicate a charge status of the power cell.

19. The system of claim 18, wherein the controller is further configured to control illumination of the indicator light to indicate operational data of the power cell.

20. The system of claim 19, wherein power cell operational data comprises at least one of amount power used, type of charge termination, hours of run time, and power cell temperature.
